(19) United States
(12) Patent Application Publication
(10) Pub. No.: US 2008/0021776 A1
(43) Pub. Date: Jan. 24, 2008

(54) Method of promoting the sport of inland surfing

(76) Inventor: Thomas J. Lochtefeld, La Jolla, CA (US)

Correspondence Address: Patent Office of J. John Shimazaki, PLLC, P.O. Box 650741, Sterling, VA, 20165, US

(21) Appl. No.: 11/784,693

(22) Filed: Apr. 9, 2007

Related U.S. Application Data
(60) Provisional application No. 60/790,516, filed on Apr. 7, 2006.

(51) Int. Cl. G06Q 30/00

(52) U.S. Cl. 705/14

(57) ABSTRACT

The invention relates to a method of promoting the development of an inland surfing facility within a real estate development by creating a strategic package of products and services that can be promoted and sold by a surfing consortium to the developer of the development. The package is preferably developed by the consortium and comprises 1) a commitment to develop and construct at least one wave pool and surf wave generator for producing quality waves at the wave venue site, 2) a commitment by at least one branded surf related retailer to occupy and lease commercial retail space at the development and cross promote its brands and sponsored athletes with the development, and 3) a commitment to sponsor and conduct at least one surf event at the wave venue site.

### RELATED APPLICATION

This application claims the benefit of the filing date of U.S. provisional application Ser. No. 60/790,516, filed Apr. 7, 2006.

### FIELD OF THE INVENTION

This invention relates to surfing, and in particular, to a business model that economically facilitates and promotes the development of world-class surf pools through creation of a myriad of revenue streams that synergistically market and cross-promote the surfing lifestyle to grow the sport of inland surfing.

### BACKGROUND OF THE INVENTION

One of the appeals of wave pools is that they replicate beaches and waves that exist in nature, but in locations where waves are not normally available. Traditional wave pools are typically man-made bodies of water, with a wave generator located at one end, and a simulated beach located at the other end, wherein waves are created that travel across the pool and break onto the beach.

From the standpoint of surfing, however, one of the shortcomings of traditional wave pools is that they normally do not create waves suitable for surfing on conventional surfboards. These traditional pools are typically designed to produce about a 1 meter high mixed sea of peaked wave forms, for swimmers and participants floating in inner-tubes, who bob up-and-down, in the water. Several wave manufacturers have attempted to create multi-wave forming capabilities, including solitary surfable waves that break obliquely to the beach. However, even those that claim they are surfable typically only create a single wave for a long period interval (.e.g., sixty seconds), which reduces throughput and accessibility. Additionally, due to the need to serve the lowest common denominator, (i.e., a beginning surfer), gently sloping pool bottom configurations are typically designed to produce a gentle spilling wave shape, as opposed to the curling or plunging quality that results from steeply sloped beaches, as preferred by intermediate or advanced surfers.

Most importantly, the capital cost to build, and the carrying cost to operate, a dedicated surfing pool has not yet been viewed as economically viable by recreation and real estate developers. Surfers normally prefer bigger waves, and bigger waves require a bigger pool. And, the greater the pool size, the higher the cost. Additionally, the bigger the wave, the more energy is required to create each wave. This cost is compounded by the fact that surfers generally prefer to ride on the waves alone, without interference from other surfers. This can result in a low user throughput when compared with a traditional wave pool.

For example, a traditional wavepool designed for inner-tubers and swimmers may accommodate a capacity of 500 users per hour. If each user pays $5, then, the total revenue per hour is $2,500. In a multi-wave pool configured for surfing, however, in order to equal the $2,500 gross revenue figure, assuming one surfable wave every 60 seconds, then, each wave would require a sales price of $41.66, which is a steep price to be paid for a ride with an estimated 10 second duration. Moreover, the primary and often singular revenue stream generated under the current operating regime is generated only by daily-use fees.

For these reasons, surfing has eluded all but the most enthusiastic participants who are willing to travel to the ocean where actual surfable waves are created, and, for the very same reasons, has almost altogether eluded those living in land-locked communities where ocean access is remote. Even those who previously lived near the coast are often forced to move away, to live and work in areas far from the coast, and therefore, have to give up the sport.

One of the reasons for this is that surfing takes time, and practice, and normally, it must be done when and where the waves occur. Not only must there be access to the waves, but one must surf when the “surf is up,” which isn't very often, even in the best of locations. Accordingly, not only must inland dwellers travel to where the waves are, but they must do so at just the right time, i.e., when the waves are suitable for surfing. If the waves aren't big enough, or just aren't happening, then any attempt to practice will be difficult or impossible.

For these reasons, surfing has usually been viewed as a sport only for the young and carefree who are willing and able to take time out of their lives, to live near the coast, close to where the waves are, and devote a significant amount of time, including a large portion of their lives, to surf. Because of these time considerations, and the link between the ocean and surfing, surfing has often involved a complete lifestyle choice, including forgoing meaningful employment and other productive opportunities for an extended period of time, e.g., which might otherwise interfere with surfing when the waves are at their best. But it has also been this unique lifestyle choice that has spawned a unique attitude and culture specific to surfing that has become popular and attractive and that has generated a huge commercial industry.

Despite, or perhaps, because of, these choices, surfing, and the surfing culture, have become extremely popular, especially among the youth, and have generated huge revenues, commercially, in many related industries, including music, motion pictures, surf merchandise, beachwear, food and beverage, sunglasses, travel, etc. Therefore, even as surfers move away from the coast, find work, and become productive citizens, and give up the sport, the spirit of surfing normally continues in their hearts and minds, and the love of the sport pervades. Nevertheless, thus far, those feelings are largely suppressed, and aren't acted upon, as most individuals find themselves with no opportunity to continue the sport they once participated in, and loved. In this respect, the only way that most land-locked citizens could enjoy the sport is by visiting a wave pool nearby, but thus far, the surfing experience at most traditional wave pools has been mediocre at best, and the surfing lifestyle and core retail products and services that are often associated with surfing, have heretofore not had any desire to be associated nor marketed in connection with these traditional wavepool facilities.

Notwithstanding the failed linkage between traditional wavepools and the surf retail lifestyle, many inland suburbs and planned communities constitute thriving metropolitan markets with strong commercial demand for surf lifestyle retail, e.g. beachwear, music, movies, sunglasses, etc., Furthermore, visitors to and residents of these inland suburbs often yearn for the days when they could surf at the beach anytime. The problem is, now, there is nowhere to surf, so they don't.

The confluence of these various forces and attitudes has encouraged those in the surfing industry to seek-out new technologies to promote, expand and grow the sport of inland surfing, and find solutions to mitigate the problems of high costs and low capacity. For example, standing wave generating machines, such as the Flow-Rider®, have been designed and built to permit those who live and work away from the coast to participate in the sport of sheet wave surfing, i.e., surfing on a specially designed ‘flowboard’ over the top three-inch layer of water that is formed to a wave-like shape. Other wave generating devices for creating surfable waves in a wave pool have also been considered; including those discussed in applicant's U.S. Pat. No. 6,928,670, entitled the Moving Reef Wave Generator. The patents relating to these technologies are incorporated herein by reference.

But the advent of these wave generating technologies does not, by itself, bring surfing on conventional surfboards on a quality surfing wave to the inland masses. Specific financial and economic incentives are still required, to motivate developers and investors who are normally used to building conventional planned communities, shopping malls, golf courses, hotels and water parks, to finance, plan and construct new and risky ventures, relating to surfing (on real surfboards in a manner appreciated by advanced surfers), in locations where conventional planned mixed-use communities or inland destination resorts are otherwise prospering.

Therefore, there is a need to develop a strategy to promote, expand and grow the sport of inland surfing, but to do so in a methodical, commercially viable and business-oriented way. The goal is to make surfing available to the inland masses, wherein a means is necessary that gives incentives to land developers and investors to take the risks associated with building wave pools dedicated to surfing, in locations where conventional retail centers, country clubs, resorts and swimming pools are currently the norm.

### SUMMARY OF THE INVENTION

The present invention relates to a method of promoting the sport of inland surfing, by giving incentives for land developers, such as those involved in building planned residential mixed use communities, shopping malls, lifestyle retail centers, golf course resorts, ski resorts, hotels, destination time share/condominium resorts, and water parks, to incorporate an inland surfing facility into the development, and promote and market the development to specific targeted groups.

The method comprises first forming a consortium of like minded organizations and individuals, for the purpose of promoting, expanding and growing the sport of inland surfing, wherein the consortium can bring such organizations and individuals together, for the purpose of implementing a comprehensive strategy/alliance, dedicated to providing a collection of specialized products and services relating to inland surfing.

The strategy implemented by the consortium preferably includes providing and offering a strategic package of products and services, which can be offered for sale to developers, comprising: 1) a commitment or agreement by the consortium to help develop and construct at least one surf wave generator, such as one capable of producing surfable waves, with a minimum quality standard to service from beginner to advanced surfers on standard surfboards, to be constructed in connection with a wave pool on a wave venue site, 2) a commitment or agreement by at least one branded surf related retailer (who typically sponsor and financially support professional surf athletes) to occupy and lease commercial retail space at the proposed development venue site and cross promote its/their brand(s) and athlete(s) with the development, 3) a commitment or agreement by the consortium to sponsor and conduct at least one surf event at the wave venue site, such as a competitive event utilizing their sponsored professional surf team(s) and/or athlete(s), including providing publicity and advertising for such events, or alternatively, licensing a surfing associated athlete or board sport organization to sponsor and conduct such events using branded surf retail sponsored professional athletes, and 4) an integration of specific thematic elements into the entire development tied directly to the history, culture and/or lifestyle of surfing.

The resulting land development, in this case, can be virtually any real estate project of a certain critical mass, such as a planned mixed-use residential community, a large shopping mall, resort hotel, a golf resort, a ski resort, a condominium or timeshare development, an entertainment sports complex, a water theme park, etc., that incorporates and benefits from the above elements of the package. For example, a planned residential community can be constructed and modeled after the formulas previously pioneered by golf and ski resorts, but instead, the development can incorporate a surfing theme, including, at its center, a surf wave generator and wave pool capable of creating head-high surfable waves. A large entertainment retail development can also incorporate, instead of a passive central lake feature with conventional lake activities (e.g., paddleboats), a surfing venue, with appropriate surf shops, retailers, and beach-food vending, in the vicinity of the surfing site.

A unique aspect of the invention is that it compiles a pre-packaged bundle of products and services specific to inland surfing, which can be more easily implemented by the developer, to help ensure that the proper elements necessary for commercial success can be provided in advance, so that the developer does not have to solicit the same elements independently. This ensures that the synergy of multiple revenue streams is created to support the cost of the recreational infrastructure, and the themed elements are authentic to ensure compatibility with the retail brands.

By way of analogy, consider the business model normally associated with a conventional planned mixed-use community centered around a golf course and country club, with restaurants and specialty shops, etc. In this case, the developer would ordinarily have to independently hire a golf course architect to design the course, and have it built by a golf course construction company, and then would have to solicit branded retailers, restaurants, hotels, etc., to encourage them to enter into leases and licenses, and negotiate with them, to provide cross-promotional opportunities. Furthermore, the developer would have to pay a significant amount of money to hire professional golfers to help promote and sponsor the golf course, whether independently or in conjunction with the golf retailers.

In addition, in the context of a golf course, it is often desirable for developers to attract and encourage a professional golf tournament to be held there, which would bring immediate prestige to the golf course, and automatically boost the golf course's reputation, and bring immediate publicity and commercial success to the resort. At the present time, however, the only way that a golf course developer could hope to successfully invite a professional golf tournament to be held at that venue would be to spend years promoting the golf course and attempting to increase its reputation among the golfing elite, which would necessarily have to begin by hiring a well known golf course architect, and inviting and hiring professional golfers to play the course and provide testimonials about the quality of the course, etc. And this would all have to be done, over the course of many years, with no guarantees, e.g., because of the competition among golf courses, there would only be a remote chance that a professional golf association would consider having a tournament there, and the development would have to be lucky enough to be chosen for that to happen.

Now contrast that scenario with the present invention, and method, which is designed to provide in advance, a package of pre-selected products and services, with all the elements in place necessary for the inland surf development to succeed, to with: 1) a commitment from a well known and prestigious surf pool manufacturer or developer to design and build the surfing pool to the strict specifications of the professional inland surfing association, 2) a commitment by branded surf retailers to occupy and lease multiple preferably individually branded company-owned retail stores at the development, with sponsored professional surfers who are committed to cross-promoting their brands with the development, 3) a commitment in advance by a professional surfing association to hold annually a professional surf tournament at the venue site, including providing all promotions and advertising therefore, including the sponsorship of professional surfers, and 4) a unique ability to market the history, culture and lifestyle of surfing to potential residents or customers of the development. By considering the elements of the present invention, in contrast to a typical golf course development, it can be seen that the present method is unique, novel, and can provide significant value to the developer.

There are also additional differences that exist between the present method and previous business models for land and real estate development. For example, unlike traditional developments, involving golf courses, ski resorts, etc., which have a long track record of success, a development dedicated to inland surfing is currently without a history of success to draw upon. In such case, land developers may consider developing and operating an inland surfing facility to be a risky venture, raising doubts about whether such a facility could succeed on its own. There is also no evidence that the advent of a surfing facility would attract the right kind of residents, and customers, to the development, nor that having such a facility, would increase the property value of the development, unlike in conventional developments, such as those involving golf courses, ski resorts, etc., which have shown a propensity for significantly increasing the value of the land.

Because the concept of inland surfing is new, and presents a certain amount of risk to the developer, the developer of inland surf parks stand to benefit greatly from the following: the built-in marketing and customer drawing power provided by the surfing consortium; the pre-lease commitment of branded surf retailers for company-owned retail stores; the pre-appearance commitment of professional surfers; the pre-commitment of professional competitive events; the synergy of a myriad of complementary revenue streams; and the unique ability to market the surfing lifestyle, all of which, can potentially increase revenue, reduce cost and provide incentives to land developers to take the risks associated with the project.

By incorporating an entire package of these strategic products and services, in this fashion, relating to inland surfing, the invention is able to provide to the developer in advance a multiplicity of potential revenue streams, such as those relating to residential/hotel/timeshare, food & beverage, retail, events, memberships, media, and sports ticketing. These ancillary revenue streams can reduce risk and concomitantly underwrite needed financing to enable project construction. The surf wave generator can be viewed as a common area amenity, much like a golf course, ski resort, lake, or swimming pool would serve in a conventional development project. The method contemplated by the invention, when executed properly, provides the financial business incentive to expand the ocean lifestyle to millions of prospective landlocked customers, resulting in increased sales and profit to the developer, the branded surf retailers, athletes, wave manufacturers, competitive boardsports organizations, and all of the entities involved in the development.

The proposed method will also bring surfing to the inland masses.

### DETAILED DESCRIPTION OF THE INVENTION

One goal of the present invention is to raise awareness and generate publicity for the sport of inland surfing, wherein one of the main objectives is to make inland surfing available to more people throughout the country, and to do so in manner that generates increased revenue for the surfing industry, including the consortium and its members.

The strategy implemented by the consortium preferably includes a strategic package of products and services, which can be offered for sale to developers, comprising: 1) a commitment or agreement by the consortium to help develop and construct at least one surf wave generator, such as one capable of producing surfable waves with a minimum quality standard to service from beginner to advanced surfers on standard surfboards, to be constructed in connection with a surf pool on a wave venue site, 2) a commitment or agreement by at least one branded surf related retailer (who typically sponsor and financially support professional surf athletes) to occupy and lease commercial retail space at the proposed development venue site and cross promote its/their brand(s) and/or athlete(s) with the development, 3) a commitment or agreement by the consortium to sponsor and conduct at least one surf event at the wave venue site, such as a competitive event utilizing their sponsored professional surf team(s) and/or athlete(s), including providing publicity and advertising for such events, or alternatively, licensing a surfing associated athlete or board sport organization to sponsor and conduct such events using branded surf retail sponsored professional athletes, and 4) an integration of specific thematic elements into the entire development tied directly to the history, culture and/or lifestyle of surfing.

The consortium can achieve its objectives by using the consortium membership to 1) create an emotional and experiential connection between landlocked consumers and the inland surfing lifestyle which authenticates or legitimizes the associated participant member retail brands; 2) locate branded participant company-owned retail stores at each inland wave venue site to guarantee a leasehold revenue stream to the developer for finance and loan underwriting purposes; and 3) sanction professional competitions and professional athlete appearances, which in turn, drives visitor attendance and associated site revenues, as well as, increasing the overall brand media, marketing and promotion relating to inland surfing.

The resulting development, in this case, can be virtually any real estate project or development of sufficient size and scope, such as those discussed above, including planned residential mixed-use communities, large shopping malls, hotels, resorts, sports centers, hotel/time share/condominium developments, water theme parks, etc. For example, a planned mixed-use residential community can be constructed to incorporate surfing, and the surfing lifestyle, as a theme, including, as its central role, a surf wave generator capable of creating head-high surfable waves. A large shopping mall can also incorporate a surfing venue, with appropriate shops and retailers in the vicinity of the surfing site.

The Consortium and its Members:

The invention contemplates initially creating and organizing a consortium consisting of organizations, manufacturers, retailers and/or individuals who have a common goal of working to promote, expand and grow the sport of inland surfing. The selection of members within the consortium preferably consists of those who currently conduct business in the surfing industry, such as the following: 1) celebrity surfers and professional board sport athletes, 2) branded surf retailers that are in the business of selling and marketing surf related products, including clothing, beachwear and other related products, and in particular, those branded retailers that sponsor professional surfing athletes; 3) branded manufacturers of surf related equipment such as surf boards and bodyboards, and in particular, those manufacturers that sponsor professional surfing athletes; 4) manufacturers of water rides and wave generating technologies; and 5) surf dedicated media partners that distribute surfing content to its audience, e.g., TV networks (ESPN, OLN, FOX, FUSE, GrindTV, etc.,) or print/web publications (Surfer, Surfing, Transworld Surf, Happy, Surfline, Swell, Surfer's Village, etc.).

Depending on the specific objectives of the consortium, membership can be voted upon, based on prescribed guidelines and/or by-laws, which can be developed and agreed upon in advance by the consortium. Various members can be given certain voting rights, based on percentage, which can depend on the overall make-up of the consortium. For example, each member may hold an equal ownership status and a voting right. Moreover, expansion of membership can be based on predetermined criteria, such as, for example, when the gross sales from a prospective new member exceeds the sales volume of an existing member, wherein such new brand may be offered a voting participant status.

Different member tiers or levels can be created, such as creating a first tier membership with voting rights for those who perform task-critical functions, and a second tier membership without voting rights for those whose functions are not as critical. For example, a well-known branded surf retailer or a celebrity surfer may be indispensable to the consortium's goals, and purposes, and therefore, might be named as a first tier member, whereas, the consortium may be able to pick and choose between various wave generator manufacturers or media distribution companies, in which case, they might be considered second tier members. A second tier member may have many of the same rights as a first tier member, except without the right to vote. Developers may also be considered as members, such as second tier members, in which case they could be given second tier membership rights. Virtually any organizational set up is contemplated by the present invention.

The consortium preferably provides the following services in connection with the development:
1) Sanctions each wave venue as suitable for support by the consortium, based on criteria set forth in advance by the consortium;
2) Serves as point of contact to promote national and international sponsorship, media and public relations;
3) Cross-promotes the wave venue with member marketing and entertainment;
4) Serves as the point of contact as leasing agent or tenant representative in lease negotiations between the developer and consortium retail members; and
5) Serves as the point of contact as a sports marketing agent in media broadcast rights between the developer and print/broadcast/web media organizations.
   Wave Generating Device:

To accomplish the consortium's goals, the consortium will preferably adopt an open platform whereby a variety of particular wave making technologies or devices capable of generating a wave endorsed by surfers can be approved for use at consortium sponsored surf venue sites. This will insure a high value inclusive approach supported by multi-national sponsorship, thereby avoiding technology and/or sponsor balkanization and a corresponding value diminution. This also enhances competition among wave generator manufacturers, which can keep pricing and terms competitive, and give incentives to manufacturers to provide high quality products and services.

Alternatively, the consortium can place certain restrictions and limitations, such as based on the quality and/or size of the waves produced by the wave generating device, since the consortium has an interest in promoting the best wave generating technologies and devices available for growing the sport. For example, the consortium may require that the wave generator be adapted to: 1) create a wave face equal to or greater than 1.5 meters in height; 2) create a wave shape prized by intermediate to advanced surfers, i.e., a curling or plunging wave; 3) facilitate maneuvers on the wave face, e.g., aerials on a consistently shaped wave analogous to a skate ramp; and 4) support the competitive events, or any combination of one or more of the above requirements. These requirements may be supplemented by technical requirements relating to wave frequency, duration, breakpoint depth, etc., created by the device.

The consortium can enter into agreements with manufacturers of wave generators, preferably with certain restrictions and limitations, i.e., relating to the type of wave generator to be incorporated into the consortium's package. For instance, the manufacturer could be required to develop and produce, exclusively for and on behalf of the consortium, and for sale exclusively in conjunction with the package, only those wave generators that meet all four of the above requirements (and associated technical requirements). On the other hand, the consortium may choose to allow the same manufacturers to develop, produce, sell or otherwise convey, any other wave generating device, not meeting the four requirements.

The consortium is preferably involved in the design, development and testing of the wave generating technologies, to ensure that the technologies are sound, function properly, and create good waves. This is due to the consortium's interest in making sure that the wave generating technologies that are sold as part of the package are built to high quality standards, and are capable of creating high quality waves. The goal, in this respect, is to build the best possible wave generator, which best replicates surfing, and which has wide commercial appeal, at a reasonable cost. In order to market the surfing lifestyle, it is critical that the technology be of sufficient quality so as not to dilute the positive attributes of the individual participant brands. The technology must also be safe, to ensure that the consortium's liabilities, as well as the developer's and manufacturer's, are limited. The consortium will preferably have the wave generating technology tested by professional surfers, who can provide testimonials, and in turn, endorse the technology in advertising and promotional campaigns.

Media Rights:

The consortium preferably obtains and/or retains all or a portion of all media rights relating to the wave generating device, including all rights to all images, photographs, videos, film reproductions, digital computer or internet reproductions or other likenesses of the wave generator, any participant riding thereon, and any associated sponsor banners or advertising signage placed on or in the immediate vicinity of the wave generator. These rights can also include the exclusive right to control all media, print, radio, television, video, internet web broadcasts, CD-ROM, DUD, DAT, film, still images, photographs and posters, including all copyrights and trade dress rights, movies, third-party advertising or sponsorships, or any other distribution media and production, in connection with any stand-up riding, sponsored events or television/motion picture production.

The consortium preferably retains the exclusive right to control the use of these media rights, to promote or advertise any third-party product or service, which allows the consortium to organize, sponsor and promote the branded surf retailer's products and organized events, as described herein. However, the consortium may allow the wave manufacturer, the surf retailer, and/or the developer, to retain the right to produce and distribute media advertising in the ordinary course of their businesses, to promote and advertise their own products and services. When web-broadcast rights are involved, the consortium may allow the wave manufacturer, the surf retailer, and/or the developer the right to use the web-broadcast images, on condition that the broadcast format and presentation of images is approved by the consortium, and/or has a direct link to consortium approved website(s), including any web site belonging to an approved venue sponsor.

Likewise, the consortium may retain all such media rights from the developer who purchases the package and develops a surf park at the development, as a means of assisting the consortium in its efforts to promote the package, the wave generators, the surf retailer's stores, and the proposed development, including all phases thereof. In this respect, the consortium preferably requires the manufacturer to agree to cooperate, in requiring each developer that purchases a wave generator, to enter into an agreement with the consortium, wherein all such media rights, including the images and web-broadcast rights, are granted to the consortium. In return, the consortium preferably agrees to grant to each wave manufacturer, retailer and/or developer a non-exclusive right to use the media rights to the extent necessary in the ordinary course of their businesses. Virtually any arrangement relating to media rights which will provide the benefits described herein is contemplated by the invention.

Surfing Celebrities:

The consortium membership preferably includes celebrity surfers who are well-known to the industry, and preferably, to most consumers. Celebrities can bring perceived value and legitimacy to the consortium's activities and functions, and therefore, to the developers.

For example, celebrity surfers can be hired or asked to participate in designing and/or testing the wave generating technologies that are being developed and produced by manufacturers, which can bring added-value, legitimacy and prestige to the technologies themselves, not to mention promote and advertise the technologies.

Celebrities can participate in the competitive events that are sponsored and conducted by the consortium, to raise interest in and bring publicity to the events.

Celebrities can be hired or asked by the branded surf retailers to do commercials and participate in advertising, which can help cross-promote their branded products with the development.

Celebrities can participate in commercials and advertising directly for the development, as a means of promoting their development, e.g., planned community, shopping mall, or water theme park, etc., as the case may be.

The availability of celebrity surfers brings added value to these projects, wherein they can give an incentive to developers to incorporate the package into the development. Having them included in the package helps save the developer the time and effort of having to recruit the celebrities themselves.

Branded Surf Retailers:

To promote the package, the consortium can be used as a means of bringing together a number of branded retailers in the surfing industry, and obtaining commitments from them to occupy and lease commercial retail space at the development. In turn, the surf retailers can use the wave to create an emotional connection between the real ocean, the sport of surfing, and optimally, their retail brand, thereby legitimizing their products as “real” as opposed to a “wanna-be” or “poser” brand. Additionally, the surf retailer will use their brand advertising and commercials to cross promote their surf brands with the development. This can give developers an incentive to incorporate the package into their development, and develop storefront space for the retailers, wherein, in return, the developer can receive an agreement from the surf retailers to occupy and lease the space, and provide the desired cross-promotion.

For the developers, the surf retailers not only provide a source of additional revenue, via the leases, but can also generate significant publicity and advertising for the development, in connection with their brands. Of particular interest are those branded surf retailers that sponsor professional athletes to wear their branded retail goods. It is these branded surf retailers that carry the greatest market strength and legitimacy. Current examples include: Quiksilver®, Billabong®, Hurley®, Volcom®, O'Neill®, Reef®, Rip Curl®, and Rusty®. An added benefit that these surf retailers bring is that they can generate national and international interest, with broad consumer appeal, wherein the marketing and promotional campaigns that they develop can be extended to national and international markets. That is, the campaigns can be designed to promote the development to potential consumers from around the world, wherein the campaigns could provide benefits in the form of extensive marketing and promotional value on a scale not achievable by the developer alone.

Preferably, with respect to each retailer that elects to participate in the package, and agrees to occupy and lease retail space at the venue sites, an agreement would be reached between the consortium, the retailer, and the developer, wherein the benefits of the consortium, and its members, can be passed on to the developers. In such case, at a minimum, a lease agreement is preferably entered into between the developer, on one hand, and each of the branded surf retailers, on the other hand, upon terms and conditions to be mutually agreed upon by the parties. For example, in a typical application, each surf retailer participant could be offered a premier 3,000 to 10,000 square foot branded storefront to retail their own product lines at each sanctioned venue site. In return, the retailer will agree to occupy the space, pay the developer monthly rent, and provide the related promotional and marketing benefits discussed above. The specific terms and conditions governing the space, which can be designed to benefit the parties involved, can be negotiated on a case by case basis, or preferably by a consortium designated tenant representative.

Competitive Events:

In connection with the sale of each package, and any sales agreement relating thereto, the consortium preferably will agree to commit to sponsoring and conducting, or having sponsored and conducted, at least one surf event per year, including providing publicity and advertising therefore. In such case, the consortium preferably will provide the applicable rules and regulations governing the conduct of the events, and the developer will agree to have the events conducted under such rules and regulations.

In any sales agreement executed between the consortium and a developer, relating to the package, the consortium preferably will agree to include terms and conditions requiring the consortium or other licensee to sponsor and conduct at least one surf event per year, in the manner described above, and the consortium shall be required to do so. The consortium preferably has the right to choose the appropriate terms and conditions governing the surf events, and how they are to be sponsored and conducted, including which caliber of athlete is to be featured and the right to name the event sponsor, control venue branding, design competition bibs, and event communication. The consortium may agree to sponsor more than one surf event per year, and may request a licensee such as a surfing associated athlete or boardsports organization to sponsor and conduct such competitive surf event using branded surf retail sponsored professional athletes.

An event to be sponsored or conducted by the consortium or licensee may include competitive, professional or demonstrative events, such as by professional athletes sponsored by the branded surf retailers and conducted in association with the surf generating device built at the venue site. A competitive event is one that includes athletes competing for prize money awards, or other valuable consideration, and a professional event is one that uses paid athletes. Virtually any type of event sponsored or conducted by the consortium or licensee that helps achieve the above objectives is contemplated by the present invention.

The consortium or licensee may have members or other organizations form teams that compete against one another, which can be part of a league or circuit. The league or circuit can be part of, or be distinct from, the current Association of Surfing Professionals (ASP/WQS), or International Surfing Association (ISA) or similar sports league. The consortium may promote each team, either as teams, or as individuals within each team. Individual competitions, such as for individual prize money, can also be conducted.

The consortium preferably provides and controls the publicity and advertising relating to the events. As discussed above, the consortium shall retain the media rights relating to the surf generating device sufficient to allow the consortium to properly promote and advertise the wave generator, the development, and the appropriate members of the consortium who are involved in the events, including surf retailers. For example, the consortium may partner with television studios, such as ESPN, OLN, and FOX, who can be permitted to distribute opening event competitions, invitationals, and ultimately a competitive circuit. Revenues from these extraneous events can be distributed according to the percentage membership interest within the consortium.

Promoting the Package:

The consortium preferably retains the exclusive right to promote the package, including the wave generating devices that are incorporated into the package, and the exclusive right to negotiate and enter into binding sales agreements with developers, with respect to the sale of all elements of the package. Such package preferably comprises the following: 1) an agreement by surf retailers who sponsor professional surfing athletes to occupy and lease retail space and cross promote with their brands, 2) an agreement by the consortium to sponsor and conduct at least one annual surf event that features those sponsored professional athletes, 3) an agreement by a manufacturer to design and build a wave generating device on the venue site in accordance with the specifications of the consortium, 4) an agreement by developers to grant all media rights relating to the wave generator to the consortium, in exchange for a branded surf retailer lease commitment and athlete appearance commitment, and 5) an agreement by a media company to distribute the images and content generated at the venue or by a competition.

The manufacturer may retain the limited right to promote the wave generator, and the package, as an agent for, and under the direction of, the consortium. In promoting the wave generator, the manufacturer may provide notice to each customer that the wave generator is offered for sale exclusively in conjunction with the package. The manufacturer may coordinate all terms and conditions of sale of the wave generator, including those that relate specifically to the package, with the consortium. The manufacturer may enter into a sales agreement with the developer directly, for the sale of the wave generator, but preferably only after an agreement between the consortium and the developer relating to the terms and conditions of sale of the package has been reached.

Each branded surf retailer preferably, under a separate agreement, and in conjunction with the purchase of the package, enters into a lease with the developer, under terms and conditions agreeable to both parties. The consortium would preferably act as a tenant representative in lease negotiations between the developer and prospective consortium retail tenants. This would result in one point of contact for the developer and better negotiating strength for consortium retailers. The lease preferably specifies the terms and conditions upon which the retailer shall occupy the retail space at the development. Each retailer, and developer, preferably coordinates the execution of the lease with the consortium, particularly in connection with the terms and conditions relating to the package, including professional athlete venue competitions, as well as, the publicity, advertising, pro athlete appearances, and marketing efforts to be provided by the surf retailer and consortium in conjunction with the development, which should be in conjunction with the media rights retained by the consortium.

What is claimed is:

1. A method of promoting the development of an inland surfing facility within a real estate development, comprising:
1) providing a commitment or agreement to develop and construct at least one surf wave generator capable of producing surfable waves to be constructed in connection with a surf pool on a wave venue site;
2) providing a commitment or agreement by at least one branded surf related retailer to occupy and lease commercial retail space at the development and cross promote its brand with the development; and
3) providing a commitment or agreement to sponsor and conduct or have sponsored and conducted at least one surf event at the wave venue site.

2. The method of claim 1, wherein the method comprises developing a consortium of individuals and/or businesses to promote the sport of inland surfing, wherein the consortium brings together the elements in the method steps and promotes it as a package to a developer of the development.

3. The method of claim 1, comprising getting a commitment by a wave pool manufacturer to develop and construct said surf wave generator.

4. The method of claim 1, wherein said surf wave generator is capable of at least one of the following:
1) producing surfable waves with a minimum quality standard to service from beginner to advanced surfers on standard surfboards;
2) creating a wave face equal to or greater than 1.5 meters in height;
3) creating a curling or plunging wave shape;
4) creating a consistently shaped wave analogous to a skate ramp; or
5) providing a predetermined wave frequency, duration, and/or breakpoint depth.

5. The method of claim 1, comprising having the retailer sponsor and financially support at least one professional surf athlete, and having the surf athlete cross promote the retailer's brand in association with the development.

6. The method of claim 1, wherein the surf event is a competitive, professional or demonstrative surf event utilizing at least one sponsored professional surf team and/or athlete.

7. The method of claim 1, comprising providing publicity and advertising for said surf event.

8. The method of claim 1, comprising licensing a surfing associated athlete or board sport organization to sponsor and conduct said surf event, using at least one branded surf retail sponsored professional athlete.

9. The method of claim 1, wherein the method comprises the additional step of integrating specific thematic elements into the development to help promote the history, culture and/or lifestyle of surfing.

10. The method of claim 1, wherein the real estate development comprises a real estate project or development taken from the group consisting of the following: planned residential mixed-use communities, shopping malls, hotels, resorts, sports centers, hotel/time share/condominium developments, and water theme parks.

11. The method of claim 2, wherein the consortium comprises at least one business or individual taken from the group consisting of the following:
1) a celebrity surfer;
2) a professional board sport athlete;
3) a branded surf retailer in the business of selling and marketing surf related products;
4) a branded surf retailer that sponsors at least one professional surfing athlete;
5) a branded manufacturer of surf related equipment;
6) a branded manufacturer of surf related equipment that sponsors at least one professional surfing athlete;
7) a manufacturer of water rides and/or wave generating technologies; and
8) a surf dedicated media partner that can distribute surfing content to its audience.

12. The method of claim 2, wherein the method comprises 1) requiring the developer to grant media rights relating to the surf wave generator to the consortium, and/or 2) providing an agreement by a media company to distribute the images and content generated at the wave venue site and/or the surf event.

13. A package of products and/or services for promoting the development of an inland surfing facility within a real estate development, wherein the package can be promoted and sold to a developer, comprising:
1) a commitment or agreement to develop and construct at least one surf wave generator capable of producing surfable waves to be constructed in connection with a surf pool on a wave venue site;
2) a commitment or agreement by at least one branded surf related retailer to occupy and lease commercial retail space at the development and cross promote its brand with the development; and
3) a commitment or agreement to sponsor and conduct or have sponsored and conducted at least one surf event at the wave venue site.

14. The package of claim 13, wherein the package is developed by a consortium of individuals and/or businesses to promote the sport of inland surfing, wherein the consortium brings together the elements of the package and promotes it to the developer of the development.

15. The package of claim 13, comprising getting a commitment by a wave pool manufacturer to develop and construct said surf wave generator.

16. The package of claim 15, wherein said surf wave generator is capable of at least one of the following:
1) producing surfable waves with a minimum quality standard to service from beginner to advanced surfers on standard surfboards;
2) creating a wave face equal to or greater than 1.5 meters in height;
3) creating a curling or plunging wave shape;
4) creating a consistently shaped wave analogous to a skate ramp; or
5) providing a predetermined wave frequency, duration, and/or breakpoint depth.

17. The package of claim 13, comprising having the retailer sponsor and financially support at least one professional surf athlete, and having the surf athlete cross promote the retailer's brand in association with the development.

18. The package of claim 13, wherein the surf event is a competitive, professional or demonstrative surf event utilizing at least one sponsored professional surf team and/or athlete.

19. The package of claim 13, comprising providing publicity and advertising for said event.

20. The package of claim 13, comprising licensing a surfing associated athlete or board sport organization to sponsor and conduct said surf event, using at least one branded surf retail sponsored professional athlete.

21. The package of claim 13, wherein the package comprises a commitment or agreement to integrate specific thematic elements into the development to help promote the history, culture and/or lifestyle of surfing.

22. The package of claim 13, wherein the real estate development comprises a real estate project or development taken from the group consisting of the following:
planned residential mixed-use communities, shopping malls, hotels, resorts, sports centers, hotel/time share/condominium developments, and water theme parks.

23. The package of claim 14, wherein the consortium comprises at least one business or individual taken from the group consisting of the following:
1) a celebrity surfer;
2) a professional board sport athlete;
3) a branded surf retailer in the business of selling and marketing surf related products;
4) a branded surf retailer that sponsors at least one professional surfing athlete;
5) a branded manufacturer of surf related equipment;
6) a branded manufacturer of surf related equipment that sponsors at least one professional surfing athlete;
7) a manufacturer of water rides and/or wave generating technologies; and
8) a surf dedicated media partner that can distribute surfing content to its audience.

24. The package of claim 14, wherein the package comprises 1) requiring the developer to grant media rights relating to the surf wave generator to the consortium, and/or 2) providing an agreement by a media company to distribute the images and content generated at the wave venue site and/or the surf event.
